(19) United States
(12) Patent Application Publication
(10) Pub. No.: US 2025/0024249 A1
(43) Pub. Date: Jan. 16, 2025

(54) METHODS AND DEVICES FOR MANAGING A TEMPORARY IDENTITY IN WIRELESS COMMUNICATION

(71) Applicant: Sony Group Corporation, Tokyo (JP)

(72) Inventors: Lars NORD, Lund (SE); Torgny PALENIUS, Barsebäck (SE)

(21) Appl. No.: 18/708,938

(22) PCT Filed: Nov. 2, 2022
(86) PCT No.: PCT/EP2022/080591

§ 371 Date: May 9, 2024

(30) Foreign Application Priority Data
Dec. 2, 2021 (SE) 2151470-8

(51) Int. Cl. H04W 8/26

(52) U.S. Cl. CPC H04W 8/26

(57) ABSTRACT

A method carried out in a UE for managing temporary IDs for use in communication with a wireless network, the method comprising: receiving (510) a poll message comprising a first temporary ID from the wireless network; transmitting (540) an uplink message to the wireless network in response to the poll message, responsive to the first temporary ID matching a stored current ID obtained by a first iteration in the UE of an algorithm configured to iteratively generate temporary IDs; 10storing (550) a second temporary ID as the current ID, wherein the second temporary ID is an output of a second iteration of the algorithm in the UE next after said first iteration.

### TECHNICAL FIELD

This disclosure is related to wireless communication between a wireless device and a wireless network. Specifically, solutions are provided for configuring a temporary identity for use in communication between the UE and the wireless network.

### BACKGROUND

Various protocols and technical requirements for wireless communication have been standardized under supervision of inter alia the 3rd Generation Partnership Project (3GPP). Improvement and further development are continuously carried out, and new or amended functions and features are thus implemented in successive releases of the technical specifications providing the framework for wireless communication.

Wireless communication may in various scenarios be carried out between a wireless network and a wireless device. The wireless network typically comprises an access network including a plurality of access nodes, which historically have been referred to as base stations. In a 5G radio access network such a base station may be referred to as a gNB. Each access node may be configured to serve one or more cells of a cellular wireless network. A variety of different types of wireless devices may be configured to communicate with the access network, and such wireless devices are generally referred to as User Equipment (UE). Communication which involves transmission from the UE and reception in the wireless network is generally referred to as Uplink (UL) communication, whereas communication which involves transmission from the wireless network and reception in the UE is generally referred to as Downlink (DL) communication.

Every UE needs to be powered in some way to be able to communicate with the wireless network. Regardless of the capability of the UE, energy conservation is a relevant factor to consider. One clear development that can be identified in the evolving character of the specifications which provide regulations and guidelines for wireless communication, is the implementation of a larger variety of types of UEs, including less complex UEs, and related simplified, constrained, or relaxed regulations with regard to communication configurations associated with such less complex UEs. This can be seen as part of an evolution towards an Internet of Things (IoT) context, where a vast amount of connectable UEs and UE types are conceivable, some of which may be configured only for simple communications tasks, such as to occasionally report a measured value of a certain parameter. For at least some types, such UEs may be expected to be able to operate for very long periods of time without needing a battery recharge or replacement, in particular for UE types being configured for long periods of inactivity between scarce and short communication instances.

Legacy 3GPP procedures provide for the use of temporary identities, or temporary IDs, for use in communication between the wireless network and the UE. One objective thereof is to maintain anonymity of the UE in communication signaling. An example is the Globally Unique Temporary UE Identity (GUTI). The purpose of the GUTI is to provide an unambiguous identification of the UE that does not reveal the UE or the user's permanent identity. It also allows the identification of the entity or function within the wireless network which manages the connection of the UE. It can be used by the network and the UE to establish the UE's identity during signaling between them. The GUTI typically has two main components: one that uniquely identifies the managing entity which allocates the GUTI, and one that uniquely identifies the UE managed by that managing entity.

In communication between the wireless network and the UE, the temporary ID is used in clear text when the UE is paged. It is therefore required that the temporary ID, such as a 5G-GUTI in the example of 5G, is changed after every page event. This is done by the managing entity, the Access and Mobility Management Function (AMF) in the core network, which provides a new 5G-GUTI using a UE Configuration Update (UCU) procedure. This occurs every time a UE sends a registration request or service request to the AMF, thus every time the responds to a paging request and when doing periodic registration requests. This may imply frequent re-allocation of the 5G-GUTI. For certain scenarios, e.g. where the UE has a very simple communication task to handle, the actual communication and processing required to change the temporary ID may account for a relevant part of the energy consumption.

### SUMMARY

One object is to provide a mechanism for managing a temporary ID used for communication between a UE and a wireless network. An aspect of this object is to provide a solution which is beneficial in view of UE energy conservation. The proposed solution, which targets these objectives, is set out in the independent claims, whereas various examples thereof are set out in the dependent claims and in the following detailed description.

According to a first aspect, a method is provided which is carried out in a UE for managing temporary IDs for use in communication with a wireless network, the method comprising:
receiving a poll message comprising a first temporary ID from the wireless network;
transmitting an uplink message to the wireless network in response to the poll message, responsive to the first temporary ID matching a stored current ID obtained by a first iteration in the UE of an algorithm configured to iteratively generate temporary IDs;
storing a second temporary ID as the current ID, wherein the second temporary ID is an output of a second iteration of the algorithm in the UE next after said first iteration.

Related to the first aspect, a UE is provided, comprising:
a wireless transceiver for communicating with a wireless network; and
logic circuitry configured to control the UE to carry out the steps of the methods proposed herein.

According to a second aspect, a method carried out in a wireless network is provided for managing temporary IDs for use in communication with a UE, the method comprising:
obtaining a temporary first ID, stored as a current ID indicative of the UE, wherein the first ID is an output of a first iteration of an algorithm in the wireless network, which algorithm is configured to iteratively generate temporary IDs;
transmitting a poll message comprising the first ID;
receiving an uplink message from the UE in acknowledgment of the poll message;
storing, based on the uplink message, a second temporary as the current ID, wherein the second temporary ID is an output of a second iteration of the algorithm in the wireless network next after said first iteration.

Related to the second aspect, a network node of a wireless network is provided, comprising:
a communication interface for communicating with the UE through the wireless network; and
logic circuitry configured to control the network node to carry out the steps of the methods proposed herein.

The proposed solution thus provides a mechanism for polling, or paging, wherein temporary IDs are generated locally in the UE and in the network according to a predetermined algorithmic sequence, such that signaling for the purpose of updating a temporary ID is minimized. This results inter alia in the technical effect of saving network resources and conserving energy for the UE.

### BRIEF DESCRIPTION THE DRAWINGS

FIG. 1 schematically illustrates an implementation of a wireless communication system, in which a UE communicates with a wireless network by radio communication with a radio node.

FIG. 2 schematically illustrates a UE configured to operate with the wireless network according to various examples.

FIG. 3 illustrates an example of a particular type of UE according to FIG. 2, configured to operate by harvesting radio frequency energy from a received wireless signal, to process and transmit in the uplink by reflecting the bearer.

FIG. 4 schematically illustrates successively generated temporary IDs indicative of a UE according to various aspects of the proposed solution.

FIG. 5A illustrates a signaling diagram, identifying various aspects of the proposed solution.

FIG. 5B illustrates a signaling diagram, identifying various aspects of the proposed solution of FIG. 5A, modified with added features related to security handling.

### DETAILED DESCRIPTION

In the following description, for purposes of explanation and not limitation, details are set forth herein related to various examples. However, it will be apparent to those skilled in the art that the present invention may be practiced in other examples that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof. The terms “receive” or “receiving” data or information shall be understood as “detecting, from a received signal”.

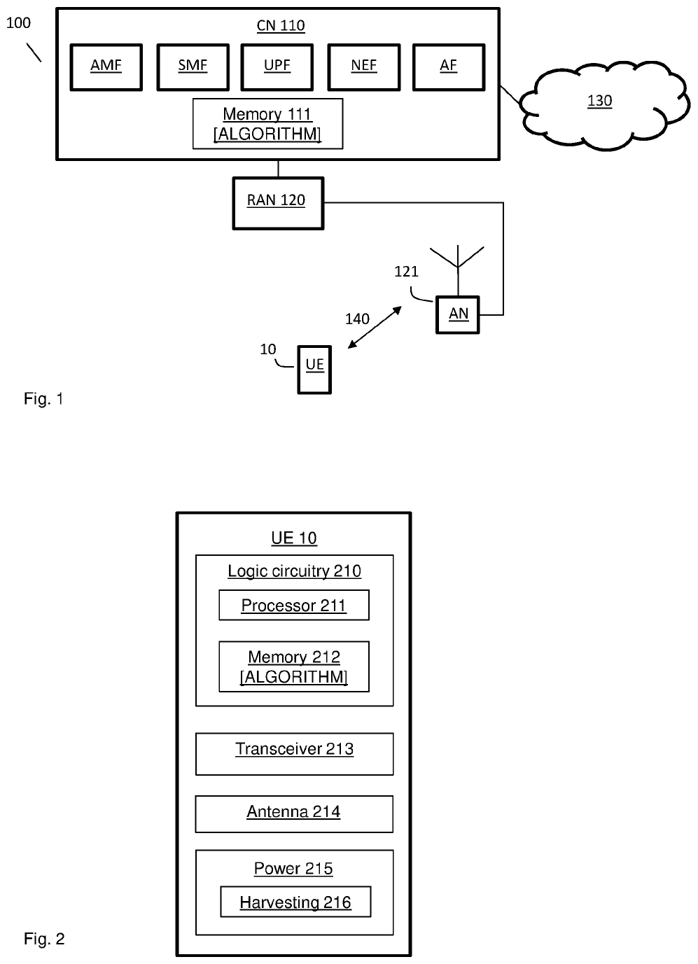

FIG. 1 illustrates a high-level perspective of operation of a UE 10 in a wireless system, configured to communicate with a wireless communication network 100, denoted wireless network 100 for short herein. The wireless network 100 may be a radio communication network 100, configured to operate under the provisions of 5G as specified by 3GPP, according to various examples. The wireless network 100 may comprise a core network (CN) 110, connectable to an external network 130 such as the Internet. The core network may comprise a plurality of core network nodes, which realize logical functions. For the example of a 5G system, as illustrated, this may inter alia include the AMF, a Session Management Function (SMF), a User Plane Function (UPF), a Network Exposure Function (NEF), and an Application Function (AF), all of which are legacy functions of the 5G system. The AF(s) may also be deployed outside of the 5G system i.e. as an application running on an application server connected to the external network e.g. the internet.

The core network is connected to at least one access network 120 comprising one or more base stations or access nodes, of which one access nodes 121 is illustrated. The access node 121 is a radio node configured for wireless communication on a physical channel 140 with various UEs, of which only the UE 10 is shown. The physical channel 140 may be used for setting up one or more logical channels between the UE and the wireless network, such as with the AMF.

Before discussing further details and aspects of the proposed method, functional elements for the UE 10, configured to carry out various tasks according to the proposed solution, will be briefly discussed.

FIG. 2 schematically illustrates an example of the UE 10 for use in a wireless network 100 as presented herein, and for carrying out various method steps as outlined. Some relevant elements or functions of the UE 10 are shown in the drawing. The UE 10 may however include other features and elements than those shown in the drawing or described herein, such as a casing, a user interface, sensors, etc., but these are left out for the sake of simplicity.

The UE 10 comprises a radio transceiver 213 for communicating with other entities of the radio communication network 100, such as the access node 121, in one or more frequency bands. The transceiver 213 may thus include a receiver chain (Rx) and a transmitter chain (Tx), for communicating through at least an air interface.

The UE 10 may further comprise an antenna system 214, which may include one or more antennas, antenna ports or antenna arrays. In various examples the UE 10 is configured to operate with a single beam, wherein the antenna system 214 is configured to provide an isotropic sensitivity to transmit radio signals. In other examples, the antenna system 214 may comprise a plurality of antennas for operation of different beams in transmission and/or reception. The antenna system 214 may comprise different antenna ports, to which the Rx and the Tx, respectively, may selectively be connected. For this purpose, the antenna system 214 may comprise an antenna switch.

The UE 10 further comprises logic circuitry 210 configured to communicate data and control signals, via the radio transceiver, on a physical channel 140 to a serving access node 121 of the wireless network 100. The logic circuitry 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic circuitry 210 may further include memory storage 212, which may include one or multiple memories and/or one or multiple other types of storage mediums. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic circuitry 210 is configured to control the UE 10 to carry out any of the method steps as provided herein. Software defined by said computer program code may include an application or a program that provides a function and/or a process. The software may include device firmware, an operating system (OS), or a variety of applications that may execute in the logic circuitry 210.

The UE 10 further comprises a power supply 215 that provides energy to the other components of the UE 10. In some examples, the power supply 215 may comprise a battery. The battery 215 may be non-replaceable, and even non-chargeable, in various embodiment of low complexity UE types.

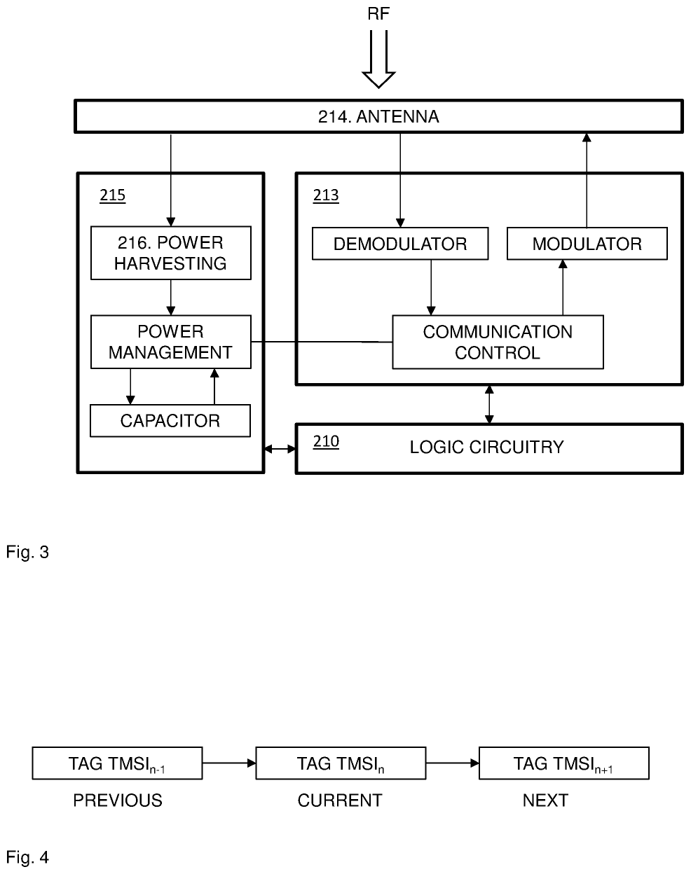

In yet another example, the power supply is configured to harvest incoming radio frequency energy, which is used to power the other components of the UE 10, so as to enable certain processing and UL transmission. FIG. 3 provides a schematic overview of such an example, usable in the UE 10, wherein the UE 10 may be configured as a passive IoT device that harvests energy to perform UL transmission. The UE 10 may thus be configured to employ so-called backscatter communication, similar to RFID tags. Backscattering is when the transceiver 213 in the UE 10 uses the DL carrier wave, noted as RF in the drawing, for both energy harvesting and using it for UL transmission by reflecting the carrier back after modulating the carrier with the UL data. Same reference numerals as used in FIG. 2 are shown in FIG. 3, although the functional elements are differently realized. In this context, and using the logical representation provided in FIG. 3, the power supply 215 may comprise a power harvesting circuit 216, connected to the antenna 214, a power management module and a capacitor, such as a supercapacitor. The transceiver 213 may comprise a communication control module, which is powered by the power management module. The communication control module may be connected to a demodulator for demodulating an incoming RF signal, and to a modulator for subsequently modulating an outgoing, “reflected”, RF signal. The logic circuitry 210, comprising a processor 211 and memory 212, is likewise energized by the power management module and connected to control operation of the at least the transceiver 213.

There are also other types of UEs, including other types of RFID device types, having high or extreme power constraints in common. The inventors have thus identified that system overhead needs to be addressed and optimized, in view of UEs operating under such high power constraints, such as various types of UEs operating under 3GPP specifications, e.g. one or more types of 5G UEs.

According to one aspect, the proposed solution addresses aspects related to UE registration overhead in a 5G system and temporary ID handling. Initial registration of the UE with the wireless network 100 typically starts with a UE registration request in legacy proceedings, which message may be a quite large message. After the registration request, a security mode procedure is performed. Once the registration is accepted, the UE receives several parameters from the network including the temporary ID, the 5G-GUTI.

It may be noted that for a low-complexity type UE 10, such as a UE operating by energy harvesting, only parts of the parameters requested upon legacy registration in 5G may be of interest. This may in particular be the case for a passive type UE, e.g. operating by backscatter communication. Legacy registration and security mode configuration includes many steps and involves interchange of several parameters and advanced algorithms, e.g. for ciphering and integrity protection. A passive UE only powered by the received RF signal may not have these kinds of capabilities. However, it is very important for system that all UEs are identifiable, trusted, and possible to charge per use. Some important information that should be sent by the UE to the wireless network 100 includes:
1. Subscription ID, SUPI (5G globally unique Subscription Permanent Identifier) or SUCI (encoded SUPI);
2. Type of device, such as passive type, RFID type, backscatter type, etc. (which may implicitly point to the “Preferred Network behaviour and Security method”;
3. “Preferred Network behaviour”=send data over NAS (DoNAS), Non-Access Stratum;
4. Security method.

After registration is accepted the UE must have a temporary ID which is used for further interactions both for DL and UL interactions.

In legacy 5G, the temporary ID, the 5G-GUTI is compiled by two parts, the GUAMI (Globally Unique AMF ID) and the 5G-TMSI (Temporary Mobile Subscriber Identity). The GUAMI is the address of the AMF that is holding the UE context and the 5G-TMSI is a UE identification created in the AMF:
<5G-GUTI>=<GUAMI><5G-TMSI>

In the context of a UE type configured to operate under severe energy constraints, such as a passive type UE configured to harvest DL RF energy, as outlined above, various solutions are described herein for handling temporary IDs. Moreover, associated security methods (integrity and ciphering) will be described, which will reduce signaling compared to legacy 3GPP 5G-TMSI and 3GPP security methods.

Significant overhead is related to the 5G-GUTI handling in the 5G system when applied to a passive UE (also referred to herein as a TAG UE). This is especially important as all the interactions with a TAG UE 10 may be based on polling data from the device. Using legacy terms, the process of the wireless network signaling the UE to establish communication is commonly referred to as paging. This includes legacy tasks of the wireless network transmitting a paging indicator that triggers the UE to check if the UE's temp ID is part of the paging message. In the context of various examples of the proposed solution, where the UE 10 is a passive UE, or TAG UE, the network signaling will also provide an RF power signal that wakes the UE. To encompass such examples, the term polling will be used herein, which at least partly provides the same function as paging. When polling, or paging, the TAG UE 10 using legacy proceedings, the 5G-GUTI would be sent in clear text, and by the 5G security standards that 5G-GUTI is used and needs to be replaced with a new 5G-GUTI. 3GPP TS 33.501 v.17.3.0 clause 6.12.3 states:

“Upon receiving Service Request message sent by the UE in response to a Paging message, the AMF shall send a new 5G-GUTI to the UE. This new 5G-GUTI shall be sent before the current NAS signalling connection is released or the N1 NAS signalling connection is suspended.”

According to the solutions proposed herein, a different approach is launched, wherein the temporary ID is instead created locally, both within the TAG UE 10 and in the wireless network 100. This way, overhead caused by transmission occasions for the purpose of determining the next temporary ID are eliminated, thus saving at least one DL transmission and one UL transmission. The algorithm may be configured to iteratively generate temporary IDs. Rather than the wireless network transmitting the new temporary ID, the algorithm will be iterated in one or more steps according to a known rule to generate a new temporary ID, which is known both in the UE 10 and in the wireless network 100, on account of the same algorithm being used.

It may be noted that most examples described herein are provided in relation to a temporary ID corresponding to 5G-GUTI. It shall nevertheless be noted that this is only one example of the context of the proposed solution. In other examples, the proposed solution for generating and updating temporary IDs may be used for e.g. a radio level temporary ID such as a Radio Network Temporary Identifier (RNTI), e.g. I-RNTI. In such alternative examples, the format of the temporary ID and the network node deploying the method could be different, than for the described examples related to 5G-GUTI.

A new temporary ID, here called 5GTAG-GUTI by way of example, is suggested to replace the 5G-GUTI used in legacy. The new temporary ID is in some examples still compiled by two parts, the GUAMI and an iterated part TAG-TMSI (instead of 5G-TMSI):
<5GTAG-GUTI>=<GUAMI><TAG-TMSI>,

The first part of the temporary ID, GUAMI, may be identical to legacy, the second part TAG-TMSI is autogenerated locally with the known algorithm, which is stored (in memory 212) and executed both in the UE 10 and in the wireless network, respectively stored in memory storage 111 used by the AMF. Thereby the 5GTAG-GUTI does not need to be sent from the AMF to the UE every time it is changed, eliminating the signaling associated with the new temporary ID exchange.

The generation of new temporary IDs is schematically illustrated in FIG. 4, showing successive generation of the iterated part. Herein, a current temporary ID part is labelled TAG TMSIₙ. The previous, i.e. last current, temporary ID part is identified as TAG TMSIₙ₋₁, whereas the next, to become current, temporary ID part is identified as TAG TMSIₙ₊₁.

The AMF may be configured to distinguish the suggested TAG-TMSI temporary ID address space from regular 5G-TMSI temporary ID address space used for regular UEs, e.g. by identification of a particular UL NAS message type, or an indicator in the NAS message that the NAS message is sent by a UE type operating under a particular power constraint, such as being a passive UE, or that the AMF is specifically configured to only handle such UE types.

There are different known types of algorithms that may be used in the proposed solution. It shall be noted that the specific character of the algorithm is not decisive for the context of the present solution. Nevertheless, it may be noted that in some examples, the algorithm is a pseudorandom number generator (PRNG), also known as a deterministic random bit generator (DRBG), which is an algorithm for generating a sequence of numbers whose properties approximate the properties of sequences of random numbers. The sequence may be completely determined by an initial value, called a seed, which as such may include truly random values. A PRNG suitable for cryptographic applications may be called a cryptographically-secure PRNG (CSPRNG). According to some examples, the algorithm may be an RSA (Rivest-Shamir-Adleman) algorithm, which involves a public key and private key, wherein the private key is kept secret in both the UE 10 memory 212 and in the wireless network memory 111. Yet another example is an Elliptic Curve Digital Signature Algorithm (ECDSA), wherein an agreement is shared between the UE 10 and the wireless network on curve parameters (CURVE, G, n). Herein, in addition to the field and equation of the curve, a base point G of prime order on the curve is required, where n is the multiplicative order of the point G.

According to one example, there is only one algorithm as specified to employ, in the UE and the wireless network, respectively. The algorithm may in such a case be predetermined, by specification. In other examples, there may be several specified algorithms, and in such case the algorithm needs to be identified. In some examples, this involves the UE 10 receiving a message from the wireless network, identifying said algorithm. Identification of the algorithm may be conveyed in the very first poll message together with a seed, or another message before the seed is received when the UE is registered. This may form part of a registration process. The algorithm may further be negotiated during the registration. In such a process, the wireless network 100 proposes an algorithm, such as a strongest and/or newest, wherein the UE 10 may or may not accept the algorithm if it supports or does not support it. In case the UE does not accept the algorithm, the wireless network 100 may propose another, older and/or less strong, algorithm until the UE 10 accepts one that it supports.

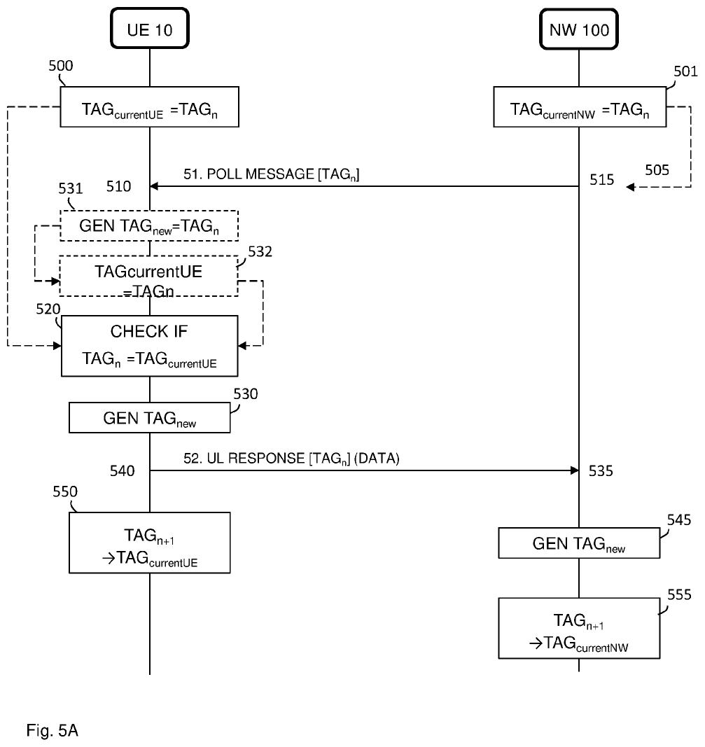

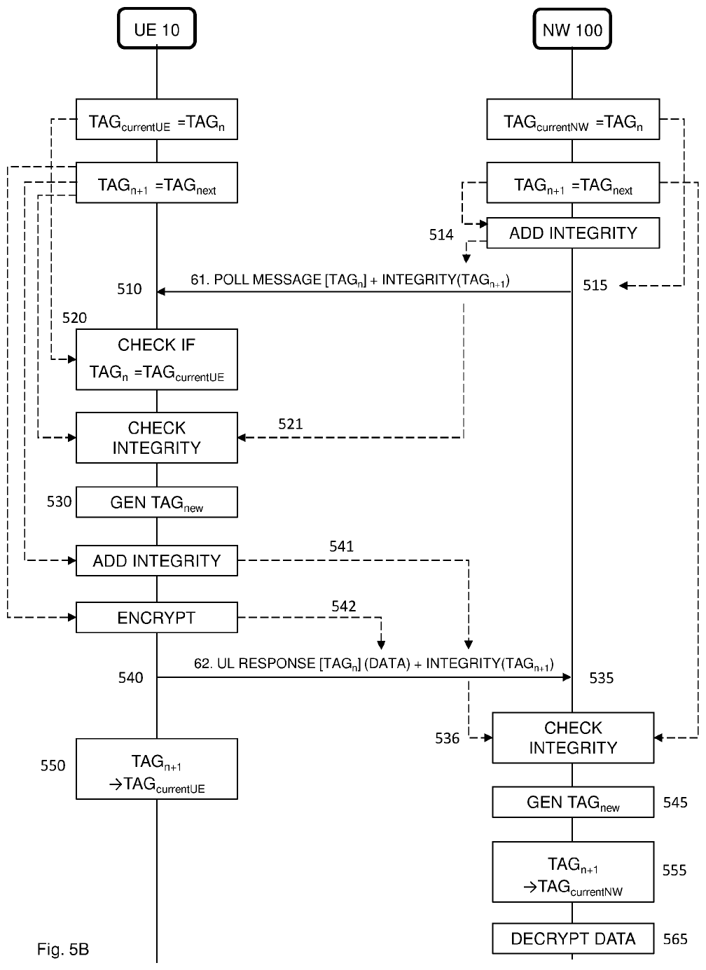

Various examples of the process for managing temporary IDs according to the proposed solution will now be described with reference to FIGS. 5A and 5B.

FIG. 5A shows a signaling diagram illustrating the general steps according to one aspect of the proposed solution, which involves a method carried out in the UE 10 for managing temporary IDs for use in communication with the wireless network 100, and a complementary method carried out in the wireless network 100. It may be noted that FIG. 5A makes reference to the shorter term TAG. In some examples, this may comprise the 5GTAG-GUTI as described, and in some examples only the TAG TMSI.

FIG. 5A shows a scenario where a TAG, is identified as the current ID (TAG_{currentUE}) in the UE 10, which current ID is a generated output of iteration n of the algorithm which is locally stored and executed in the UE 10. Meanwhile, the same TAGₙ is identified as the current ID (TAG_{currentNW}) in the wireless network 100, e.g. in memory 111. Here, the current ID is a generated output of iteration n of the algorithm which is locally stored in memory 111 in the wireless network and executed or obtained by the AMF in the wireless network 100.

Going forward, reference will be made to inter alia first and second iterations of the algorithm. This shall not be construed as limited to the very first and second iteration of predetermined sequence. Rather, these terms are merely used to identify that the second iteration follows next after the first iteration. In this context, the first iteration of the algorithm may be identified as any iteration n, generating the output TAGₙ, whereas the second iteration of the algorithm may be identified as iteration n+1, generating the output TAGₙ₊₁. From the viewpoint of the UE 10, the method comprises the following:

The UE 10 receives 510 a poll message 51, comprising a first temporary ID from the wireless network, i.e. TAG, which is stored in the wireless network 100 as the current ID.

The UE 10 transmits 540 an uplink message 52 to the wireless network in response to the poll message. This is carried out responsive to the received first temporary ID matching a stored current ID TAG_{currentUE} obtained by a first iteration in the UE of an algorithm configured to iteratively generate temporary IDs. This may be determined 520 based on a lookup test of the locally generated value TAG_{currentUE} and comparing it to the received value TAGₙ.

The UE 10 subsequently stores 550 a second temporary ID TAGₙ₊₁ as the current ID, wherein the second temporary ID is an output of a second iteration of the algorithm in the UE next after said first iteration.

The proposed solution thus involves verifying communication by comparing a received temporary ID with a locally generated temporary ID, and iterating the algorithm to produce a new temporary ID. Successively generated temporary IDs are obtained by iterating a locally stored algorithm, for use in successive polling procedures.

According to one example, the generation of the TAG, in the UE 10, and potentially in the wireless network 100, is carried out within the context of a previous polling procedure. This way, the TAG, is already stored and available in the UE 10 upon receiving the poll message 51. This is identified by the top box 500 in the drawing, wherein the TAG, was obtained in a corresponding step 530 of the preceding polling procedure, and stored as TAG_{currentUE} in step 550 of that preceding polling procedure.

According to another example, identified by the dashed boxes 531 and 532 rather than 530, the generation of the TAGₙ in the UE 10, and potentially in the wireless network 100, is carried out within the current polling procedure. In the drawing, the generation is identified by box 531, whereas box 532 provides that TAGₙ is identified as TAG_{currentUE}. This generation of TAGₙ may be triggered by the reception of the poll message 51, and powered by the RF energy of the poll message 51 where the UE 10 is a passive, energy-harvesting. TAG UE 10. In this example, the method may thus comprise generating 531, responsive to receiving the poll message 51, a new temporary ID TAG_{new} by executing the first iteration of the algorithm, wherein TAG_{new}=TAGₙ, and storing 532 the new temporary ID as the current ID. The determination 520 may nevertheless be based on a lookup test of the locally generated value TAG_{currentUE} and comparing it to the received value TAGₙ. In this example, step 550 of storing ID TAGₙ₊₁ as the current ID forms part of corresponding step 531 of the next polling procedure after the current polling procedure.

According to a related aspect, a UE 10 is provided, comprising a wireless transceiver 213 for communicating with a wireless network 100, and logic circuitry 210 configured to control the UE 10 to carry out the method above, and in various examples also any of the methods proposed herein.

From the viewpoint of the wireless network 100, the method comprises the following, which may be carried out in or under control of the AMF:

The wireless network 100 obtains 505 a temporary first ID TAGₙ, stored 501 as a current ID indicative of the UE, wherein the temporary first ID is an output of a first iteration of an algorithm in the wireless network, which algorithm is configured to iteratively generate temporary IDs.

The wireless network executes transmission 515 of a poll message 51 comprising the first ID, for receipt by the UE 10.

An uplink message 52 is received 535 in the wireless network 100 from the UE 10 in acknowledgment of the poll message 51.

Based on the uplink message 52, a second temporary ID TAGₙ₊₁ is stored 555 as the current ID, wherein the second temporary ID is an output of a second iteration of the algorithm in the wireless network next after said first iteration.

According to the proposed solution, the polling thus triggers the storing of a next iteration n+1 output of the algorithm, individually operated locally in the UE 10 and in the wireless network 100, as the current temporary ID for use in the next polling procedure, or in the current polling procedure. The next current ID is thus determined without requiring additional communication, which saves energy for the UE and network resources. This may comprise saving signaling resources. Moreover, in the case of a passive UE 10 configured for RF power harvesting, the power burst can be switched off early, meaning that a short polling duration can be obtained.

In some examples, a network node of the wireless network is provided, comprising a communication interface for communicating with the UE through the wireless network, such as through the RAN 120, and logic circuitry configured to control the network node to carry out the steps of the methods proposed herein as carried out in the wireless network. The network node may be a core network node, configured to carry out the functions of the AMF. The network node may comprise one or several separate physical units. The logic circuitry may comprise a processing device, including one or multiple processors, microprocessors, data processors, co-processors, and/or some other type of component that interprets and/or executes instructions and/or data. The logic circuitry may further include memory storage, which may include one or multiple memories configured for holding computer program code, which may be executed by the processing device, wherein the logic circuitry is configured to control the network node to carry out any of the method steps as provided herein.

In some examples, generation 530, 531 of a new temporary ID, such as a new TAG-TMSI, is performed every time the UE 10 is polled by the network 100 to send uplink data. Specifically, for a passive UE, or TAG UE, energy conveyed in the DL is harvested in the UE 10 and used to generate a new temporary ID in the UE 10. While the drawing indicates that the new temporary ID is generated after verifying 520 that received first temporary ID matches the stored current ID in the UE, the process is configured differently in some examples. In some realizations of such examples, the new temporary ID is generated 530, 531 in conjunction with reception of the poll message 51, while using RF energy harvested from the received poll message, or a received from continuous transmitted prior to the poll message from the wireless network 100. In some examples, the new temporary ID is only generated responsive to positive outcome of the UE 10 determining that the received first temporary ID TAGₙ actually matches the stored current ID TAG_{currentUE}. In yet another alternative example, the new temporary ID is generated after transmitting 540 the UL acknowledgment message 52, which identifies positive outcome of the UE 10 determining that the received first temporary ID TAG, matched the stored current ID TAG_{currentUE}.

Correspondingly, a new temporary ID is in some examples generated 545 in the wireless network 100 only responsive to receiving the UL acknowledgment message 52, which identifies positive outcome of the UE 10 determining that the received first temporary ID TAG, matched the stored current ID TAG_{currentUE}. In alternative examples, the new temporary ID may be generated 545 earlier, such as upon triggering transmission 515 of the poll message 51. In such examples, the new temporary ID may thus already be generated 545 before receiving the UL message 52, even though storing 555 the second temporary ID TAGₙ₊₁, e.g. the new temporary ID, as the current ID is carried out later, responsive to receiving the UL message 52.

In various examples, the current temporary ID is sent in plaintext in DL 51 and potentially also in UL 52, according to legacy behavior. The UL transmission 52 may further comprise data, in response to the poll message 51. In order to ensure proper and secure communication, in DL and/or UL, wherein the receiving node can determine that a message is received from a trusted sending node, mechanisms for handling integrity and ciphering may be employed. In the broad presentation of the proposed solution according to FIG. 5A, this is not considered, and may be taken care of by any known method. In such an example, the new temporary IDs TAG_{new}, which is generated 530, 555 in the UE 10 and in the wireless network 100, may be the second temporary ID TAGₙ+1, which will be used as the current ID for the next polling procedure. In the alternative example, as outlined above, the new temporary ID TAG_{new}, which is generated 531 in the UE 10, may be the second temporary ID TAGₙ₊₁

As outlined above, the auto-generated part TAG-TMSI is the Unique Identifier of the UE in the AMF. The current size of 5G-TMSI is 32 bit long, providing an address space of 2³²−1=4 294 967 295 identities per AMF. Even if the likelihood that two UEs would autogenerate the same temporary ID is very low, this needs to be considered. Two options may be considered: either trigger a new ID generation; or resolve the ID collision by performing an integrity protection check of the message, where only one of the devices will pass the integrity check. In the following, further solutions are discussed where temporary IDs, generated in both the UE 10 and the wireless network 100, are further employed for such purposes. This will basically mean that the UE 10 is uniquely identified by a pair of temporary IDs, such as a pair of TAG-TSMI. That would decrease the chances of collision by 4294967295×4294967295.

FIG. 5B shows a signaling diagram illustrating the general steps according to such a modified aspect of the proposed solution, wherein further features are shown which add further security to the communication in addition to the examples provided in FIG. 5A. Like reference numerals are used as in FIG. 5A, for the sake of consistency. The solution involves a method carried out in the UE 10 for managing temporary IDs for use in communication with the wireless network 100, and a complementary method carried out in the wireless network 100. Again, FIG. 5B makes reference to the shorter term TAG. In some examples, this may comprise the 5GTAG-GUTI as described, and in some examples only the TAG TMSI.

With reference to the foregoing, and as exemplified in FIG. 5A, the wireless network 100 polls the UE 10 with the current TAG-TMSI and the UE sends the UL data using the current TAG-TMSI as the source ID. Obviously this may, as such, not be considered to provide ample security, considering the risk that the current TAG-TMSI sent in clear text in the DL may be picked up and used by a “rouge” UE in response. It is an important factor to ensure that both the UE 10 know that it is polled by a trusted network node (AMF), and that the network 100 can trust that the UL data is sent by a UE 10 that has a subscription with the operator—that the correct UE is polled. This relates to the mentioned feature of ensuring integrity, and as mentioned the UE 10 and network 100 can use the same security methods as already specified in previous 3GPP releases, i.e. exchange security parameters and keys during the initial registration procedure's security message exchange. This involves extensive handshaking and transmission of a large number of parameters. Specifically, such procedures may be difficult for a UE that is only powered by RF harvesting when polled by the network.

With this in mind, a solution for adding security without adding too much complexity is proposed, as described by way of example in FIG. 5B. In short, the next temporary ID, e.g. TAG-TMSI, in the iteration sequence of the algorithm is used to at least integrity protect the DL poll and the UL data message. In other words, a “next to be current” temporary ID that has not yet been used as the current ID over the air yet. This may comprise adding a hash of the next temporary ID in conjunction with the clear text representation of the current ID. To further protect the data in the UL the next temporary ID could be used as a key when encrypting the message, i.e., serving as a secret input to the cryptographic algorithm.

Referring again to FIG. 5B, TAG is stored as current ID (TAG_{currentUE}) in the UE 10, which current ID is a generated output of iteration n of the algorithm which is locally stored and executed in the UE 10. The same TAGₙ is stored as the current ID (TAG_{currentNW}) is stored in the wireless network 100, e.g. in memory 111. Here, the current ID is a generated output of iteration n of the algorithm which is locally stored in memory 111 in the wireless network and executed or obtained by the AMF in the wireless network 100.

Moreover, a second temporary ID TAGₙ+1 is stored in memory 212 as a next ID (TAGₙₑₓₜ), wherein the secondary ID is an output of a second iteration of the algorithm in the UE next after said first iteration. Correspondingly, the second temporary ID TAGₙ₊₁ is stored in memory 111 as a next ID (TAGₙₑₓₜ) in the wireless network, wherein the secondary ID is an output of a second iteration of the algorithm in the wireless network next after said first iteration.

In various examples, the stored temporary IDs TAGₙ and TAGₙ₊₁ were generated in the UE 10 and in the wireless network 100 in the context of previous polling procedures. Specifically, in some examples, in a polling procedure in which a TAGₙ is used as the current ID, the n+2 iteration is generated by locally running the algorithm in the UE 10 and in the wireless network 100, while the n+1 iteration of the temporary ID is already available from storage since the nearest preceding polling procedure.

From the viewpoint of the UE 10, the method outlined in FIG. 5B thus comprises the following:

The UE 10 receives 510 a poll message 61, comprising a first temporary ID from the wireless network, i.e. TAGₙ which is stored in the wireless network 100 as the current ID.

The UE 10 transmits 540 an uplink message 62 to the wireless network in response to the poll message. This is carried out responsive to the received first temporary ID matching a stored current ID TAG_{currentUE} obtained by a first iteration in the UE of an algorithm configured to iteratively generate temporary IDs, and based on checking an integrity of the poll message 61 by using a second ID, wherein the second temporary ID is an output of a second iteration of the algorithm in the UE next after said first iteration. Determining 520 that the received first temporary ID matches a stored current ID TAG_{currentUE} may be made based on a lookup test of the stored value TAG_{currentUE} and comparing it to the received value TAGₙ. The method may further comprise checking 521 an integrity of the poll message by identifying an integrity protection of the poll message as matching the second ID, which is stored as TAGₙₑₓₜ in the UE 10.

In some examples, the UE 10 integrity-protects 541 the uplink message 62 by using the second ID as part of a hash function or other integrity protection function. Alternatively, the UE may integrity-protect the uplink message 62 with a hash function that does not use the second ID. Where the UE 10 transmits data in the UL message 62, the UE 10 is in some examples further configured to encrypt 542 the data based on the second ID, and transmit the encrypted data in said uplink message.

The UE 10 subsequently stores 550 the second temporary ID TAGₙ₊₁ as the current ID.

From the viewpoint of the wireless network 100, the method comprises the following, which may be carried out in or under control of the AMF:

The wireless network 100 obtains 505 a temporary first ID TAGₙ, stored as a current ID indicative of the UE, wherein the temporary first ID is an output of a first iteration of an algorithm in the wireless network, which algorithm is configured to iteratively generate temporary IDs.

The wireless network executes transmission 515 of a poll message 61 comprising the first ID, for receipt by the UE 10, wherein the poll message 61 is integrity-protected 514 using a second temporary ID TAGₙ₊₁, wherein the second temporary ID is an output of a second iteration of the algorithm in the wireless network next after said first iteration.

An uplink message 62 is received 535 in the wireless network 100 from the UE 10 in acknowledgment of the poll message 61.

The wireless network 100 may be configured to check 536 the integrity of the message 62, using the stored secondary ID.

Based on the uplink message 62 passing the integrity check 536, the temporary ID TAGₙ₊₁ is stored 555 as the current ID for the next polling procedure. It will thus be understood that in a next polling procedure, wherein the n+1 iteration of the temporary ID is applied as the current ID, the n+2 iteration of the temporary ID is used for integrity protection/checking, and/or for ciphering/deciphering.

According to the proposed solution, the polling thus triggers the storing of a next iteration n+1 output of the algorithm, individually operated locally in the UE 10 and in the wireless network 100, as the current temporary ID for use in the next polling procedure. The next current ID is thus determined without requiring additional communication, which saves energy for the UE and network resources.

In some examples, generation 530 of a new temporary ID, such as a new TAG-TMSI, is performed every time the UE 10 is polled by the network 100 to send uplink data. Specifically, for a passive UE, or TAG UE, energy conveyed in the DL is harvested in the UE 10 and used to generate a new temporary ID in the UE 10. In some realizations of such examples, the new temporary ID is generated 530 in conjunction with reception of the poll message 61, while using RF energy harvested from the received poll message, or energy received from an RF signal transmitted prior to the poll message from the wireless network 100, e.g. a transmitted continuous wave signal. In some examples, the new temporary ID is only generated responsive to a positive outcome of the UE 10 determining that the received first temporary ID TAG, actually matches the stored current ID TAG_{currentUE} and responsive to a successful integrity-check based on the second ID. In yet another alternative example (not shown), the new temporary ID is generated after transmitting the UL acknowledgment message 62, which identifies a positive outcome of the UE 10 determining that the received first temporary ID TAG, matched the stored current ID TAG_{currentUE}.

Correspondingly, a new temporary ID is in some examples generated 545 in the wireless network 100 only responsive to receiving the UL acknowledgment message 62, which identifies positive outcome of the UE 10 determining that the received first temporary ID TAGₙ matched the stored current ID TAG_{currentUE}, and based on successfully integrity-checking 536 the UL message 62.

Where data is received 535 in the UL response message 62, and the data is encrypted as outlined, the wireless network 100 is configured to decrypt 565 the data using the stored second temporary ID TAGₙ₊₁.

According to one aspect, the UE 10 must be registered to the wireless network 100. This may involve the network 100 identifying contact with the UE 10 and identifying the common algorithm to employ as local identical versions in the UE 10 and in the wireless network, respectively.

In some examples, the UE may be registered by receiving a synchronization message from the wireless network, comprising a seed for use as input to the algorithm to generate a temporary ID in the UE.

The UE 10 is thereby configured to generate an initial temporary ID indicative of the UE by executing the algorithm stored in the UE using said seed, and to store the initial temporary ID as the current ID.

The UE 10 then transmits an acknowledgment message to the wireless message, to trigger storage in the wireless network of the initial temporary ID as generated using the local copy of the algorithm in the wireless network.

The wireless network 100, such as the AMF, may on the other hand operate a corresponding procedure:

An initial temporary ID indicative of the UE 10 is generated by executing the algorithm stored in the wireless network using a specific seed.

A synchronization message is transmitted from the wireless network, comprising said seed to the UE, to trigger the UE to generate the initial temporary ID using its local copy of the algorithm in the UE.

The wireless network receives an acknowledgment message from the UE 10 in response to the synchronization message, and stores, based on the acknowledgment message, the specific temporary ID as the current ID.

According to various examples of the proposed solution, a new temporary ID generation is triggered every time the UE 10 is polled by the wireless network 100 and sends UL data. Nevertheless, it is still possible that either the UE 10 or the AMF loses synch, e.g. such that the TAG_{currentUE} does not match the TAG_{currentNW}, due to them being the output of different iterations of the common algorithm. For this purpose, a recovery process is proposed. According to one example, the recovery process includes “re-registration” with the wireless network 100 based on the registration process described above. However, before re-registration is performed the AMF is in some examples configured to check N steps backwards or forwards to attempt to re-synch with the UE, i.e. recent previous or next iterations of the algorithm. In one example, the wireless network is configured to, responsive to not obtaining an UL response message 52, 62 in response to a poll message, change the current ID in the wireless network (TAG_{currentNW}) obtained as output of an iteration k to the output of an iteration k+x, where x is iteratively selected and used in a DL poll message 51, 61 according to a predetermined schedule until a poll response message 52, 62 is obtained or the sequence ends. In this context, x may follow a sequence of both positive and negative numbers (e.g. [1, −1, 2, −2, 3, −3], only negative (e.g. [−1, −2, −3], or only positive (e.g. [1, 2, 3]).

There are many ways how the auto-generation and synchronisation can be done, one way is that the AMF provides a new “seed” to the ID generation algorithm, the UE acknowledges the receipt of the new seed and the two entities have recovered and are in synch.

From the perspective of the UE 10, a process for re-synchronizing a UE with the wireless network may comprise the steps of:
receiving a synchronization message from the wireless network;
generating a specific temporary ID in the UE based on the synchronization message;
storing the specific temporary ID as the current ID;
transmitting an acknowledgment message to the wireless message, to trigger storage in the wireless network of the specific temporary ID as generated using a local copy of the algorithm in the wireless network.

As exemplified, the synchronization message may be indicative of a new seed for input to the algorithm, or indicative of a specific iteration of the algorithm.

Various aspects of the proposed solution have been described in the foregoing. Unless where clearly contradictory, the features of any example provided herein may be combined in any way.

1. A method carried out in a UE for managing temporary IDs for use in communication with a wireless network, the method comprising:
receiving a poll message comprising a first temporary ID from the wireless network;
transmitting an uplink message to the wireless network in response to the poll message, responsive to the first temporary ID matching a stored current ID obtained by a first iteration in the UE of an algorithm configured to iteratively generate temporary IDs;
storing a second temporary ID as the current ID, wherein the second temporary ID is an output of a second iteration of the algorithm in the UE next after said first iteration.

2. The method of claim 1, further comprising:
checking an integrity of the poll message by using the second ID.

3. The method of claim 1, further comprising:
integrity-protecting the uplink message by using the second ID.

4. The method of claim 1, further comprising:
generating, responsive to receiving the poll message, a new temporary ID (TAGnew) by executing the first iteration of the algorithm; and
storing the new temporary ID as the current ID.

5. The method of claim 1, further comprising:
generating, responsive to the first temporary ID matching the current ID, a new temporary ID by executing the algorithm.

6. The method of claim 5, wherein the new temporary ID is a third temporary ID, generated by a third iteration next after the second iteration of the algorithm in the UE.

7. The method of claim 6, the method further comprising:
storing the third temporary ID in the UE for integrity-checking a next poll message.

8. The method of claim 5, wherein the new temporary ID is the second ID.

9. The method of claim 1, further comprising:
encrypting data in the UE based on the second ID;
transmitting the encrypted data in said uplink message.

10. The method of claim 1, wherein the uplink message comprises the first temporary ID.

11. The method of claim 1, comprising:
receiving a synchronization message from the wireless network;
generating a specific temporary ID in the UE based on the synchronization message;
storing the specific temporary ID as the current ID;
transmitting an acknowledgment message to the wireless message, to trigger storage in the wireless network of the specific temporary ID as generated using a local copy of the algorithm in the wireless network.

12. The method of claim 11, wherein the synchronization message is indicative of a new seed for input to the algorithm.

13. The method of claim 11, wherein the synchronization message is indicative of a specific iteration of the algorithm.

14. The method of claim 1, comprising:
receiving a message from the wireless network, identifying said algorithm.

15. The method of claim 1, comprising:
harvesting energy of a downlink transmission received in the UE in conjunction with the poll message.

16. A method carried out in a wireless network for managing temporary IDs for use in communication with a UE, the method comprising:
obtaining a temporary first ID, stored as a current ID indicative of the UE, wherein the first ID is an output of a first iteration of an algorithm in the wireless network, which algorithm is configured to iteratively generate temporary IDs;
transmitting a poll message comprising the first ID;
receiving an uplink message from the UE in acknowledgment of the poll message;
storing, based on the uplink message, a second temporary ID as the current ID, wherein the second temporary ID is an output of a second iteration of the algorithm in the wireless network next after said first iteration.

17. The method of claim 16, further comprising:
integrity-protecting the poll message by using the second ID.

18. The method of claim 16, further comprising:
checking an integrity of the uplink message by using the second ID.

19. The method of claim 16, further comprising:
generating, responsive to the uplink message, a new temporary ID by executing the algorithm.

20. The method of claim 19, wherein the new temporary ID is a third temporary ID, generated by a third iteration next after the second iteration of the algorithm in the wireless network.

21-30. (canceled)
